(19) United States
(12) Patent Application Publication
(10) Pub. No.: US 2007/0096876 A1
(43) Pub. Date: May 3, 2007

(54) Adaptive RFID devices

(76) Inventors: Raj Bridgelall, Plano, TX (US); Ahmad Chini, San Jose, CA (US); Curtis A. Carrender, Morgan Hill, CA (US); John Price, Morgan Hill, CA (US)

Correspondence Address: James C. Scheller, Jr.;BLAKELY, SOKOLOFF, TAYLOR & ZAFMAN LLP, Seventh Floor, 12400 Wilshire Boulevard, Los Angeles, CA, 90025-1026, US

(21) Appl. No.: 11/584,361

(22) Filed: Oct. 20, 2006

Related U.S. Application Data
(60) Provisional application No. 60/729,144, filed on Oct. 20, 2005.
(60) Provisional application No. 60/736,587, filed on Nov. 12, 2005.

(51) Int. Cl. H04Q 5/22; G08B 13/14; H04B 5/00

(52) U.S. Cl. 340/10.1; 340/572.1; 455/41.1

(57) ABSTRACT

Techniques for RFID communication adaptive to an environment are provided. An RFID reader includes a processor and a reconfigurable hardware element. The reconfigurable hardware element is reconfigurable by the processor in response to a predetermined condition. Non-volatile memory stores configuration code for the reconfigurable hardware element. In specific embodiments, the predetermined condition can be the presence of a mixed tag population, proximity to an interferer, historical read rates, RF noise level, and reader location, as well as other factors.

This application claims the benefit of the filing dates of U.S. provisional patent application Nos. 60/729,144, filed Oct. 20, 2005 and 60/736,587, filed Nov. 12, 2005, both of which are incorporated herein by reference.

### FIELD OF THE TECHNOLOGY

The present invention generally relates to the field of radio frequency identification (RFID) devices, and particularly to adaptive RFID devices and methods for using and making same.

### BACKGROUND

Goods and other items may be tracked and identified using an RFID system. An RFID system includes a tag and a reader. The tag is a small transponder typically placed on an item to be tracked. The reader, sometimes referred to as an interrogator, includes a transceiver and an antenna. The antenna emits electromagnetic (EM) waves generated by the transceiver, which, when received by tag, activates the tag. Once the tag activates, it communicates using radio waves back to the reader, thereby identifying the item to which it is attached.

There are three basic types of RFID tags. A beam-powered tag is a passive device which receives energy required for operation from EM waves generated by the reader. The beam powered tag rectifies an EM field and creates a change in reflectivity of the field which is reflected to and read by the reader. This is commonly referred to as continuous wave backscattering. A battery-powered semi-passive tag also receives and reflects EM waves from the reader; however a battery powers the tag independent of receiving power from the reader. An active tag actively transmits EM waves which are then received by the reader.

In addition to the above tag types, tags are classified by frequency band: low frequency, high frequency, and ultra-high frequency. Tags operating in different frequency bands are dissimilar and incompatible. Furthermore, these generalized frequency bands are further subdivided. For example, in the United States, ultra-high frequency RFID tags are permitted to operate from the 902 MHz to 928 MHz band, while European regulations currently specify a 865 MHz to 868 MHz band.

Even within the same frequency band, tags operate with incompatible communication protocols. UHF passive RFID tags in the United States can be implemented either as bit-wide or packet-wide communications. A bit-wide tag will respond bits at a time to each bit that a reader sends after energizing the tag with an RF field. As an example, EPCglobal's class 0 specification details a bit-wide protocol. In opposite, a packet-wide tag responds with a multi-bit packet after successfully decoding a multi-bit command from the reader. Examples of packet-wide implementations are described in EPCglobal's class 1, generation 1 (“C1G1”) and class 1, generation 2 (“C1G2”) specifications. These bit and packet based specifications, which are incorporated by reference herein, can be found at the following Internet uniform resource locators:

(i) http://www.epcglobalinc.org/standards_technology/Secure/v1.0/UHF-class0.pdf;

(ii) http://www.epcglobalinc.org/standards_technology/Secure/v1.0/UHF-class1.pdf; and

(iii) http://www.epcglobalinc.org/standards_technology/EPCglobalClass-1Generation-2UHFRFIDProtocolV109.pdf

These many different types and protocols for RFID tags introduce difficulties handling mixed tag populations. For example, in certain RFID applications, tag populations will inevitably include C0, C0+, C1G1, and/or C1G2 tags, and possibly others, making it impossible or difficult for a reader to identify all the tags. Conventional multi-protocol readers attempt to address this situation using fixed design hardware consisting of logic instantiation. The hardware maintains power and processing resource for all of the computing elements that would be required for all protocols recognized by the reader. This unnecessarily creates a larger computer power overhead. A mixed tag population is one clear example where conventional RFID systems operate inefficiently in light of external factors.

Another example of an external factor resulting in reader inefficiency is proximity to an interferer. The presence of an interferer can increase the signal level received in an adverse manner. The increased signal level brings the receiver closer to its upper dynamic range limits. Near these limits, a noise enhancement effect is observed. In particular, any noise feed-through from the transmitter is enhanced, which is particularly dominant for circulator based transceiver embodiments. An interferer pushes the gain of the receiver into a non-linear region. Noise energy from the transmitter is amplified in a non-linear manner and thus creates inter-modulation distortion products in the receiver.

Conventional RFID system inefficiency may also stem from unnecessarily high read rates in context of a particular RFID application. Unnecessarily high read rates increase the overall interference generated in close proximity, as well as increase power consumption. Manual adjustment of read rates often proves to be overly burdensome and not properly optimized.

From the above it is seen that techniques for RFID devices adaptive to an environment are desired.

### SUMMARY OF THE DESCRIPTION

Techniques for an adaptive RFID system are provided. An RFID system, as shown in FIG. 1, recognizes one or more external conditions and modifies its operation in response to these conditions. External factors can include historical read rates, composition of tag population, characteristics of the backscatter signal, and location information of interferers. A soft engine, receiver channels, predictive models, or other features described herein are employed to adapt the RFID system.

In one embodiment of the present invention, an RFID reader includes a processor and a reconfigurable hardware element. The reconfigurable hardware element is reconfigurable by the processor in response to a predetermined condition. Non-volatile memory stores configuration code for the reconfigurable hardware element. In specific embodiments, the predetermined condition can be the presence of a mixed tag population, proximity to an interferer, historical read rates, RF noise level, and reader location, as well as other factors.

In another embodiment of the present invention, an RFID reader includes a processor and a switch controlled, directly or indirectly, by the processor. The reader further includes at least two receiver channels coupled to an antenna and the switch. The first receiver channel is configured to provide a gain for a received signal of a first predetermined range in strength. The gain of the first receiver channel is substantially linear over the first predetermined range. The second receiver channel is configured to provide a gain for a received signal of a second predetermined signal range in strength. The gain of the second receiver channel is substantially linear over the second predetermined range.

In yet another embodiment of the present invention, a method of operating an RFID device includes transmitting an interrogation signal. The RFID device receives a backscatter signal and determines signal strength. In response to the determination, the RFID device selects a receiver channel from a plurality of receiver channels. Each receiver channel provides a substantially linear gain over a specified range.

Various additional objects, features, and advantages of the present invention can be more fully appreciated with reference to the detailed description and accompanying drawings that follow.

### BRIEF DESCRIPTION OF THE DRAWINGS

The present invention is illustrated by way of example and not limitation in the figures of the accompanying drawings in which like references indicate similar elements.

FIG. 1 illustrates an exemplary RFID system according to an embodiment of the present invention.

FIG. 2 illustrates an exemplary RFID system according to an embodiment of the present invention.

FIG. 3 illustrates a simplified block diagram of a reader according to an embodiment of the present invention.

FIG. 4 illustrates reconfiguration elements according to an embodiment of the present invention.

FIG. 5 illustrates an exemplary reader with adaptive gain control according to an embodiment of the present invention.

FIG. 6 shows an example of adaptive gain according to an embodiment of the present invention.

FIG. 7 shows a simplified method for operating an RFID system.

FIGS. 8A and 8B illustrate use of a receive carrier signal on weak backscatter signals according to an embodiment of the present invention. FIG. 8C shows how the weak signal can be carried to quantization boundaries whereby they can be detected.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

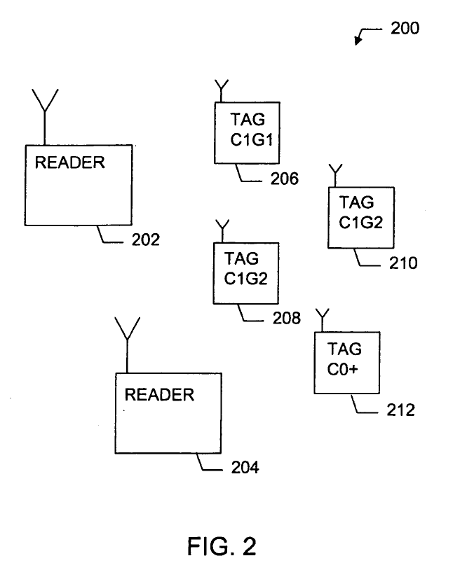

FIG. 2 illustrates an exemplary RFID system 200 according to an embodiment of the present invention. System 200 includes readers 202 and 204, but can include any number of readers (e.g., 1, 3, 4, 5 or more). At least one tag is disposed within the RF field of at least one of the readers. In one embodiment, a mixed tag population is within the RF field. For example, tag 206 is a C1G1 tag, while tags 208 and 210 are C1G2 tags. The tag population may further include class 0+tags, such as tag 212, as well as other classes and types of tags. One or more of the tags may be fabricated using fluidic self assembly which may be used to deposit an integrated circuit (IC) in a hole or receptor region in a substrate, and other tags may be fabricated with flip chip technology (in which an IC's contacts are bonded to a substrate which includes contacts that face the side of the IC containing the circuitry of the IC, rather than the backside of the IC).

The operating configuration of reader 202 varies dependent on the sensed tag population. In the event a tag population is homogenous, the configuration of reader 202 can be optimized for a communication protocol associated with the population. To be precise, reader 202 can be configured to be dedicated to a single communication protocol (e.g., Class 0, C1G1, C1G2, ISO standards, or the like), thus not wasting computing capacity or power with protocols unnecessary at that moment. If the composition of the tag population undergoes a change, reader 202 can be reconfigured for another mix of communication protocols. One or more readers may be coupled to data processing systems to perform inventory operations or other operations. For example, a reader may include an Ethernet port to allow the reader to be coupled, for data communications with the other data processing systems, through a computer network.

When mixed tag populations are present, reader 202 can be adapted to operate in a multi-protocol environment. For example, in a mixed population of tag-talk-first (TTF) and RTF (reader-talk-first) tags, some TTF tags will respond during RTF communications. Reader 202 recognizes the backscatter signal from the TTF tags during RTF communications. Reader 202 can either temporarily quiet the TTF tags, read them all first, or read them in an interleaved manner with RTF tags. The architecture of reader 202 can change to handle both TTF and RTF tag types in parallel.

Also, reader 202 may receive a backscatter signal from tag 212, a class 0+ tag, when it is modulating a C1G2 symbol on a forward link. This troublesome event can occur if both tag types receive an appropriate startup and header information, perhaps from different readers in the vicinity. For example, tag 212 can be put in a wake state by reader 204, thus allowing tag 212 to mistakenly respond to reader 202 operating under a differing RFID protocol. Under this circumstance, reader 202 can recognize a class 0 response, adaptively morph its transceiver to affect quick communications (i.e., reconfigure logic for class 0 protocol) with the class 0 tag, quiet the class 0 tag, and return to communicating with the C1G2 tag. This process can occur quickly between packets of a C1G2 command-response type protocol, or during the “ping” bin times of a C1G1 protocol.

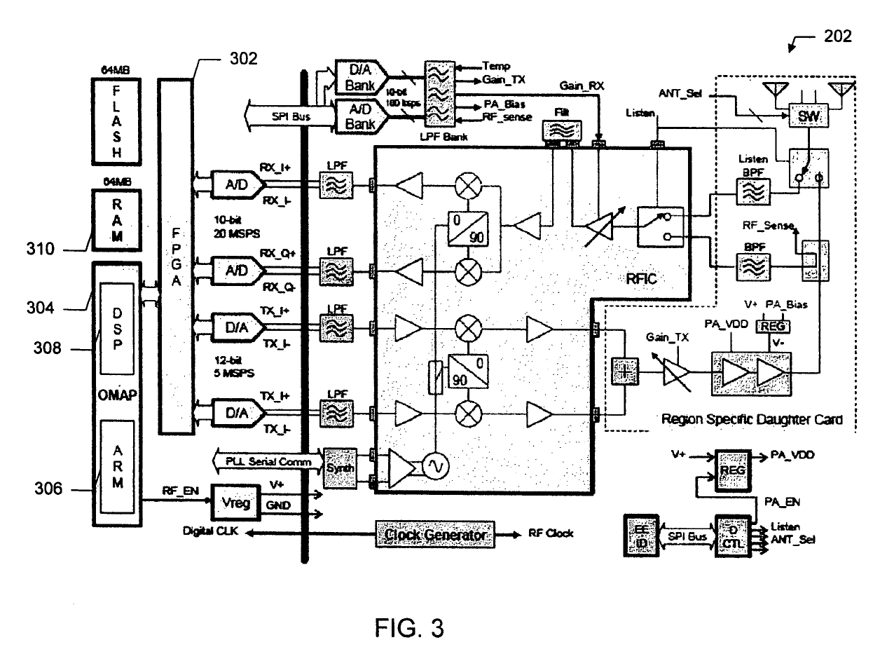

FIG. 3 illustrates a simplified block diagram of a reader 202 according to an embodiment of the present invention. Reader 202 includes an FPGA 302. FPGA 302 provides a real-time control interface to the RF front end. It manages data conversion (analog-to-digital and digital-to-analog), data transport, real-time radio configuration (e.g., gain and power settings), protocol dependent symbol timing and shaping, dense reader environment algorithms, and regulatory frequency allocations, as well as any product/vendor specific controls. In other words, FPGA 302 implements an RFID soft engine architected for improved performance and scalability.

Reader 202 also includes processor 304. Processor 304 utilizes fast data memory (e.g., RAM 310). RAM 310 can be of any suitable size, such as at least 64 megabytes, at least 128 megabytes, at least 256 megabytes, or more. In this specific embodiment, processor 304 is an OMAP chipset manufactured by Texas Instruments, which further includes ARM 306 and DSP 308. Processor 304 controls the configuration and operation of FPGA 302. DSP 308 performs signal processing for bit recovery, state machine processes for each air interface protocol standard, automatic discrimination of tag protocol, radio control functions, and reader management. In addition, DSP 308 can also log phase data from a received signal stream to allow distance measurement and direction finding. ARM 306, a general purpose processor, is configured to execute a real-time operating system to accommodate system management and monitoring functions, tag database and filtering, as well as an application program interface (API) for host communications.

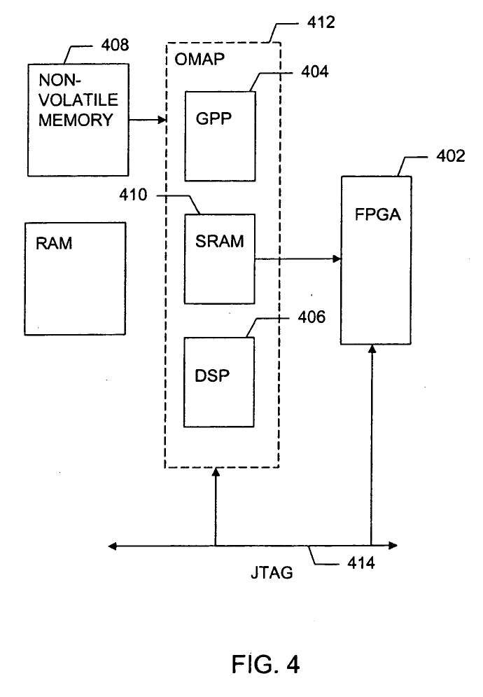

FIG. 4 illustrates reconfiguration elements according to an embodiment of the present invention. In this specific embodiment, the reconfigurable hardware element is an FPGA 402. An exemplary example is Altera's Cyclone II series FPGA detailed in Cyclone II Device Handbook, which is incorporated herein for all purposes.

FPGA 402 is configured during a power-up sequence. First, a general purpose processor (GPP) 404 of OMAP 412 will initiate its real-time operating system, and then power-up DSP 406 as needed. GPP 404 can next initiate the configuration of FPGA 402 by transferring code stored in non-volatile memory 408. Non-volatile memory 408 can be any form of solid state memory that does not require periodic refresh, including read-only memory, programmable read-only memory, erasable programmable read-only memory, flash memory, or the like. The configuration code can be stored in a compressed format in memory 408 and decompressed in real-time as it loads. Memory 408 can be of any suitable size, such as at least 64 megabytes, at least 128 megabytes, at least 256 megabytes, or more. In other words, code relating to efficient operation under each RFID protocol or mixed tag population environments can be stored in memory 408, and loaded to the reconfigurable hardware device when needed (or only when needed).

In one embodiment, a microprocessor loads in parallel the configuration from non-volatile memory 408 to a static random access memory (SRAM) 410. Following this, the configuration code can be serially transferred to FPGA 402. This configuration process can be completed in less than about 150 milliseconds, more preferably less than 130 milliseconds, and even more preferably less than 100 milliseconds. Alternatively, the configuration code can be transferred from SRAM 410 to FPGA 402 via a parallel memory mapped I/O interface. FPGA 402 can optionally decompress the configuration code in real-time as it loads. In another embodiment, FPGA 402 can be configured externally via JTAG (Joint Test Action Group) interface 414.

In another embodiment, a reader provides adaptive gain control using parallel receiver channels to address the presence of one or more interferers (e.g., other readers in the vicinity). Interferers push the gain of the receiver into the non-linear region. Noise energy from the transmitter is amplified in a non-linear manner and thus creates inter-modulation distortion, or IMD, products in the receiver. Additional details relating to non-linearity in the presence of interferers are provided in Appendix A. Adaptive gain control using parallel receiver channels provides more dynamic range and linearity than a conventional receiver.

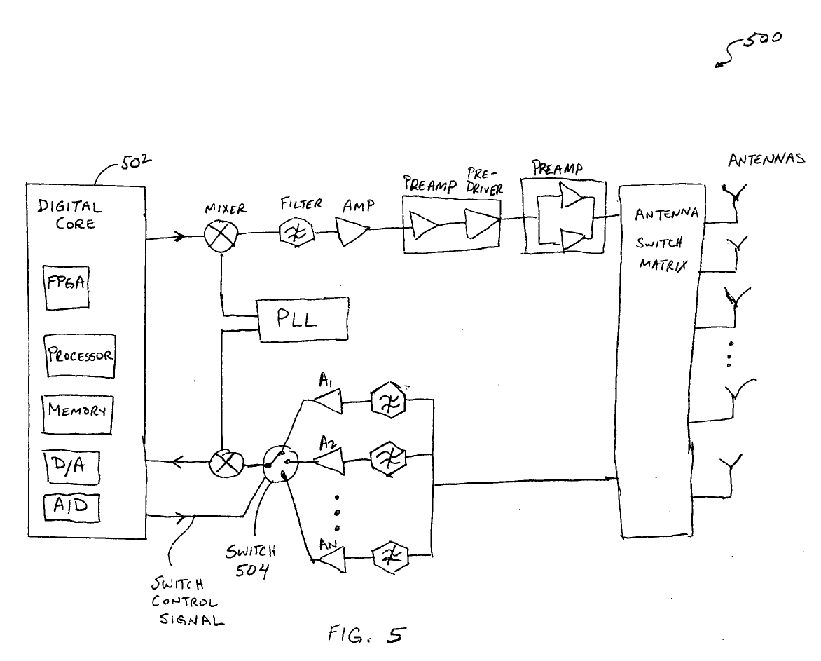

FIG. 5 illustrates an exemplary reader 500 with adaptive gain control according to an embodiment of the present invention. As shown in FIG. 5, a received signal can be selectively amplified by amplifiers A₁, A₂, . . . , A_{N}. Digital core 502 can control switch 504 based on the strength of the received signal. In the event of a strong signal near an upper dynamic range of a channel, digital core 502 can switch to another channel having a higher dynamic range limit. Similarly, in the event of a weak signal near a lower dynamic range of a channel, digital core 502 can switch to another channel having a lower dynamic range limit.

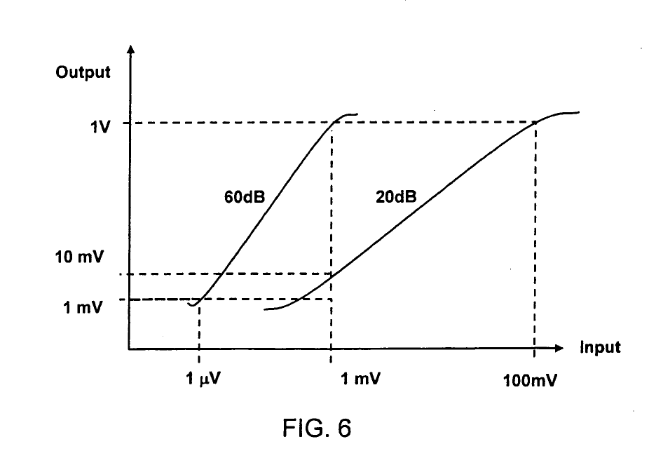

Reader 500 includes at least two receiver channels (e.g., 2, 3, 4, 5 or more channels) in an RF front-end section (alternatively, an intermediate frequency section). Each receiver channel is designed to operate in a linear region (or preferably its most linear region) with their respective signals. For example, as illustrated in FIG. 6, a first receiver channel provides a linear gain for backscatter signals with inputs ranging between about one micro-volt (μV) to about one milli-volt (mV). The gain level is set so that the output ranges from about one milli-volt to about one volt. The second receiver channel can provide a linear gain for backscatter signals with inputs ranging between about one milli-volt to about 100 milli-volts, and gain set to provide an output ranging from about 10 milli-volt to about one volt. The linear region of the second channel can overlap with the first channel, or any other adjacent channel. In a specific embodiment, a gain is about linear over a predetermined range with a root-mean-square deviation of less than about 10%, or more preferably less than about 5%. The gain of each receiver channel is predetermined and/or fixed at factory, and not capable of further adjustment when an RFID system is deployed. In another embodiment, a variable gain of each receiver channel can be tuned or altered depending on the RFID application.

Each receiver channel can have a smaller dynamic range relative to a conventional receiver channel, but better linearity for a predefined signal strength region. That is to say, two or more optimized signal gain stages in parallel provide better performance over a single receiver using gain switching. Linearity and signal integrity is much easier to practically obtain with embodiments of the present invention. It should be understood that, in a specific embodiment, selection of the appropriate receiver channel for an RF signal or intermediate frequency signal reduces or eliminates inter-modulation distortion.

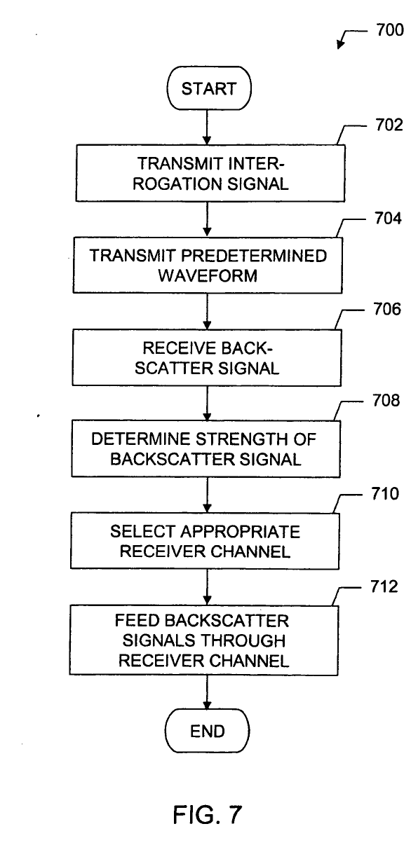

FIG. 7 illustrates a method 700 for operating an RFID device. In step 702, a reader transmits an interrogation signal to activate and/or power a tag. Next, in step 704, the reader transmits a predetermined waveform. This predetermined waveform can be designed for simplified recognition. In specific example, the predetermined waveform is a preamble sequence for a communication protocol. The preamble, being a known signal defined by the relevant protocol, is easily detected by reader 500 and thus provides an ideal window to make a channel determination. A backscatter signal is received from the tag and evaluated in real-time by the reader in steps 706 and 708. Based on the reader's determination of backscatter signal strength, one of a plurality of receiver channels is selected in step 710. In alternative embodiments, the determination can be based on other signal characteristics, such as signal clipping or intensity of signal harmonic. In one embodiment, step 710 occurs during the preamble. In step 712, the remaining portions of the backscatter signal are feed through the selected channel, the channel providing substantially linear gain over a specific strength region.

Even though close proximity to another reader introduces a problem as discussed above, it also provides opportunities for further performance improvements over conventional RFID readers. A reader according to an embodiment of the present invention maintains relative position information of other nearby readers and adapts its communication link accordingly. For instance, the reader can increase (or alternatively decrease) transmitted signal strength if it determines another reader is located behind it. Also, awareness of other readers and their respective locations allows a reader to act collaboratively with these other readers. In this situation, communication with a common tag can be coordinated to avoid interference or multiple readers can be used to triangulate tag position.

In another embodiment of the present invention, an RFID system or reader can monitor an RF spectrum and determine the extent and frequency of meaningful ambient noise. Based on this additional information, the reader can set its data rate and rate of backscatter return for better performance. The link margin is thus improved and re-tries minimized. For example, a common noise source for RFID backscatter systems is a fluorescent light. Often between 8 and 50 kHz, a fluorescent light acts as a strong source for reflected backscatter. When the reader automatically determines that a local noise source (e.g., a fluorescent light) is emitting noise at 40 kHz with harmonics at multiples of 40 kHz, the reader can adjust its data rate from the tag to avoid proximity to these specific frequencies.

An RFID system can also automatically adapt to historical read rates. This affects the overall interference generated in close vicinity and reduces power usage. The read rate for a slow moving conveyor belt can be reduced relative to a dock door. As another example, in a store, the appropriate read rate for a first shelf may be much less than the read rate for a second shelf, perhaps because its stock/inventory is not as fast moving. Read rates can be manually set or adjusted, but manual procedures often prove to be overly burdensome and not properly optimized, particularly in an environment that regularly undergoes changes.

Predictive modeling techniques can be used to automatically improve or optimize a reader's read rate. For example, a predictive model using historical read rate data over specified time period (e.g., 5 minutes, 10 minutes, 1 hour, 1 day, or more) can cause the reader to read less or more often based on this information. If tags are infrequently presented or the tag population infrequently changes, the reader can initiate a read less often. Known probabilistic estimation techniques, as well as machine learning techniques, can be applied.

In a specific embodiment, the reader combines two or more predictive models to adjust read rate, such as a short term and long term model. The long term model, using data over a long time period (e.g., 10 minutes, 20 minutes, 1 hour, or more), sets the maximum and minimum read rates. The short term model, using data over a short time period (e.g., less than 1 second, 1 second, 10 seconds, 1 minutes, or more), responds to more dynamic changes in the offered load and changes the read rate between the maximum and minimum read rates defined by the long term model. Under this embodiment, historical read rate data can be accumulated in an integrator with an appropriate time constant.

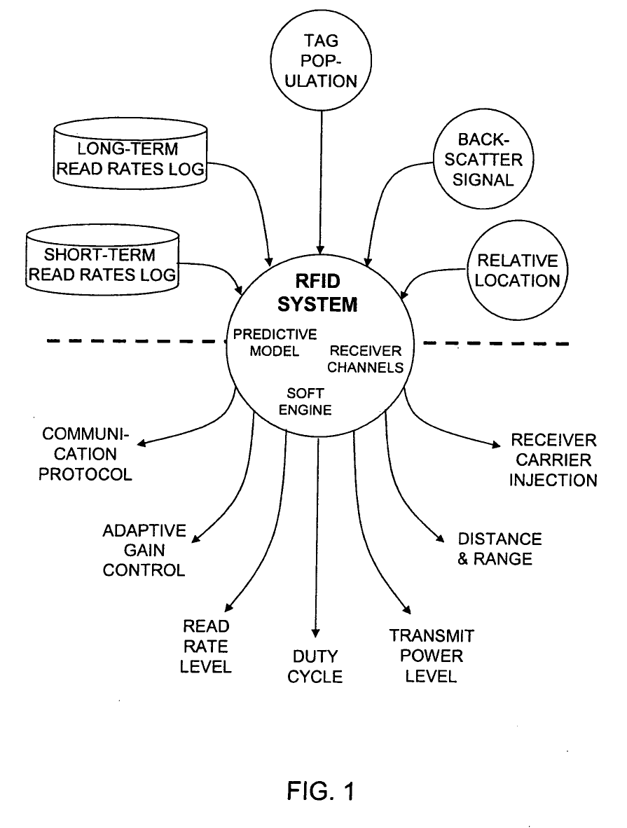

In addition, the reader can alter its duty cycle. That is, based on predictive modeling (or any of the inputs set forth in FIG. 1), the reader can modulate its power on duty cycle. For example, if the long term read rates are typically low and infrequent, then the reader need not be on at 100% duty cycle. Lowering the duty cycle minimizes interference and leaves more bandwidth for higher duty cycle readers in proximity to operate. In addition, linear predictive signal processing algorithms (as used in speech processing) can be utilized to anticipate gaps in the read cycle, thereby adjusting duty cycle accordingly.

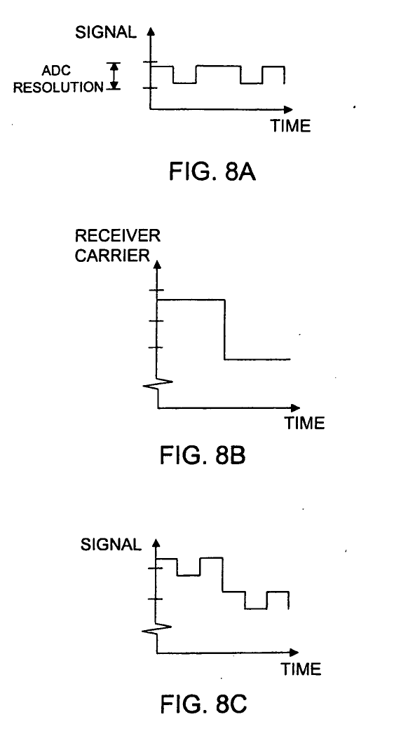

An RFID system according to another embodiment of the present invention adapts based on received signal strength. In the event a weak backscatter signal is received (or no signal is detected), in lieu of or in addition to the adaptive gain control discussed above, a receiver carrier signal can be injected in the received signal stream to improve the system dynamic range and resolution capability. Without the receiver carrier signal to ride on, the weak backscatter signal cannot pass through the signal chain unless the analog-to-digital converter has more resolution. FIG. 8A shows a weak signal that is problematic due to quantization of the digitizer, or analog-to-digital converter. FIG. 8B illustrates an exemplary receiver carrier signal that allows the weak signal to be appropriately digitized.

In specific embodiments of the present invention, the receiver carrier signal is identical to the carrier frequency for UHF tag operation. The intensity of this signal can be varied by the amount of coupling between the transmitter and receiver sections. Some amount of coupling exists in RFID transceivers. Ideally, the sum of the injected carrier and the data signal should be equal to the maximum linear dynamic range of the receiver. In non-RFID embodiments such as time-division-multiple-access (TDMA) transceivers, where backscatter signaling is not used, a separate carrier can be injected. This carrier must be offset by one or more channels from the data rate so that it can be filtered out from the data signal. Depending on the particular RFID application, the receiver carrier signal can take any arbitrary waveform, such square wave, sinusoidal, saw tooth, staircase, or the like. The preferred embodiment is a sinusoid because it has the lowest harmonic content and can be most easily filtered out from the desired data stream. The resulting, usable signal is illustrate in FIG. 8C.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

### APPENDIX A

### RFID Reader RF Nonlinearities

### Ahmad Chini, 27 Jan. 2005

This document discusses RFID reader RF nonlinearities especially in the presence of strong interference. The effect of RF nonlinearities on the carrier phase accuracy is of particular concern because of its pending utility for range and bearing estimation. This document does not quantify the amount of non-linearity in any particular product. The numbers are used only for examples. The aim of the document is not to investigate alternative solutions to deal with nonlinearities, although some solutions may be inferred from analysis. The well known two-tone inter-modulation distortion (IMD) concept is extended to an RFID reader receiving a small signal from a tag and a strong interference from another reader. Three cases of practical concern are then discussed.

It is common practice to establish receiver RF nonlinearities by analyzing the effect on two equally powered CW signals within the receiver band [1-3]. Assume x is the received signal, we can write;
x=k₁ cos(θ₁)+k₂ cos(θ₂) Eq-1
θ₁=2πf₁t
θ₂=2πf₂t Eq-2
where the desired signal is at frequency f₁ and the interference is at frequency f₂. A nonlinear device can be represented mathematically in the following series expansion.
y=a₀+a₁x+a₂x²+a₃x³ Eq-3
In Eq-3, the even order terms produce frequency components far from carrier and are filtered out after the mixer. The dominant distortion comes from the third order term which produces components close to the carrier. This is often called the 3^{rd} order inter-modulation product. If we consider Eq-3 up to the third order term and replace x by Eq-1, we obtain;
y=c₁₀ cos(θ₁)+c₂₁ cos(2θ₁−θ₂)+c₁₂ cos(2θ₂−θ₁)+ Eq-4
c₁₀=a₁k₁+0.75a₃k₁³+1.5a₃k₁k₂² Eq-5
c₀₁=a₁k+0.75a₃k₂³+1.5a₃k₂k₁² Eq-6
c₂₁=0.75a₃k₁²k₂ Eq-7
c₁₂=0.75a₃k₂²k₁ Eq-8
where c₁₀ is the magnitude of the desired signal and c₂₁ is the magnitude of the third order Inter-Modulation Distortion (IMD). The ratio of IMD to carrier signal level is a good measure of receiver nonlinearity for a given signal magnitude;

$$\frac{{c}_{21}}{{c}_{10}} = \frac{{k}_{1} {k}_{2}}{( 4 {a}_{1} / 3 {a}_{3} ) + {k}_{1}^{2} + 2 {k}_{2}^{2}} \qquad Eq \text{-} 9$$

In dB scale this is calculated to be;

$$\frac{IMD}{Carrier} = 20 log ( \vert \frac{{c}_{21}}{{c}_{10}} \vert ) \qquad Eq \text{-} 10$$

As an example assume the following;
k₁=k₂=1
a₁=1 a₃=−0.1 Eq-11

Using Eq-9 and Eq-10, we can easily calculate

$$\frac{IMD}{Carrier} \approx - 20 dB \qquad Eq \text{-} 12$$

As another example we assume that the desired signal is much weaker than interference. The total received signal level is the same as in the previous example and has the same nonlinearity parameters;
k₁=0.01 k₂=1.41
a₁=1 a₃=−0.1 Eq-13

Then we can easily calculate;

$$\frac{IMD}{Carrier} \approx - 56 dB \qquad Eq \text{-} 14$$

Notice the large difference between these two examples, but before discussing these results further, let us refer to some simulation results run in Matlab for the same nonlinear device which is shown in FIG. 1.

[image]

The signal is at frequency 910 MHz and the interference is at 912 MHz. FIG. 2 is the Power Spectral Density (PSD) of the output signal y when parameters in Eq-11 are used in the simulation. Matlab PSD command was used for this analysis. IMD is seen at 908 MHz with magnitude 20 dB below the signal at 910 MHz as suggested also by Eq-12.

[image]

Note that the signals used in simulation are CW. The large bandwidth seen at lower PSD magnitudes are merely simulation artifacts. FIG. 3 is the PSD of the output signal y when parameters in Eq-13 are used in the simulation. IMD is seen at 908 MHz with magnitude 56 dB below the signal at 910 MHz as suggested also by Eq-14.

[image]

Now we consider a case which is more difficult to analyze mathematically but is easily simulated. Assume the following parameters;
k₁=0.1 k₂=10
a₁=1 a₃=−0.1 Eq-15
The interference is much larger than the signal. Furthermore, we clip the received signal at magnitudes of ±2. FIG. 4 is the PSD of the output signal y in this case.

[image]

Note that the results of FIG. 4 are for the frequency range of 904 MHz to 918 MHz. There are many IMD components generated outside this frequency range which are not shown here. Notice also that the signal can still be recovered using a proper filter.

Discussion

We can now discuss various scenarios in an RFID environment. The focus of the following discussion is on the reader receiver.

Case I: One Reader, No Interference

In this case we assume there is one reader operating at a time. Therefore there is no cross reader interference. Also we assume there is no significant interference from other sources within the receiver bandwidth. Because the received signal is modulated, the signal is comprised of an infinite number of sinusoids that inter-modulate each other in the presence of nonlinearities. One needs to make sure that over the received signal dynamic range, the IMD is below the acceptable noise level, i.e. the signal to noise ratio is good enough for correct data recovery. Since the worst level of IMD is generated when the received signal is the largest, it is practically enough to verify successful reading in a close range test.

Case II: Two Readers, One Generating a Strong Interference

Similar to case one but we also assume there is a single dominant interferer. As we see in FIG. 2 and FIG. 3 the IMD level depends on the relative ratio of the signal and interference. The IMD level is much less when interferer is significantly larger than signal. In fact the problem in such a case is not IMD but rather the side lobes of a modulated interferer. If the system is designed to perform well under linear conditions, it should perform well with the level of nonlinearities that passes the test in case I. Sharp channel filtering (interference rejection) in the receiver, spectral shaping in the transmitter and proper multiple access scheme are requirements for good performance even under linear conditions. As we see in FIG. 4, even if the interferer signal level is so large that it is clipped in the receiver, the signal can still be extracted with sharp channel filtering. This suggests that the sharper band-pass filtering provided by super-heterodyne or low-IF architectures will provide better performance in high interference environments.

Notice that LBT readers and readers with photo eye trigger may fall under this category or case I category as they either do not see another interferer or occasionally see one.

Case II: Three Readers, Two of them Generating Strong Interferences

Similar to case one but we also assume there are two interferers of about the same magnitudes. If the inter modulated product of the two interferers fall into the signal band and the interferers are significantly larger than the signal, then a receiver designed for case I and case II may fail. In a frequency hopping system, the probability of such occurrence is small, but if we wish to cover this case we need to assure that the IMD generated is well below the minimum detectable signal level. This imposes a much larger linear dynamic range for the receiver as compared with test case I.

Phase Estimation in the Presence of IMD

As is clear from this analysis and simulation, some IMD products can be filtered out before the signal is used for phase estimation. Such filters are necessary for successful data detection in dense reader environments even if phase estimation is of no concern. When and if proper interference avoidance and/or filtering techniques are implemented, IMD could be modeled as a white noise for the purpose of phase estimation.

If IMD is not prevented or removed, then we may occasionally have strong IMD corrupting the received signal. Before using the received information for phase estimation, we should make sure the received signal is not corrupted by IMD. One may check the CRC in the associated data frame. If the data is detected correctly, then the carrier phase can be used for range estimation. This assumes use of the modulated carrier for phase recovery, which by itself is subject to our future investigation.

Conclusions

1. Use of super-heterodyne architecture for steeper band-pass channel filtering helps reduce IMD as well as adjacent channel interference.
2. Some level of non linearity is allowed in the presence of single strong interferer.
3. Maximize the linear dynamic range of the receiver to allow headroom for signal recovery in the presence of multiple strong interferers. Alternatively, we may allow some level of nonlinearity but we need to make sure that randomized or coordinated frequency hopping reduces the risk of IMD falling into the desired band.
4. When proper IMD reduction mechanisms are in place in an RFID reader, IMD will be below signal level with sufficient margin for data detection. In this case, for the purpose of Phase estimation, IMD could be modeled like additive noise below signal level.
5. If the RFID reader allows large IMD to occasionally fall into the desired signal band, then we may have to extract phase from tag modulated carrier and use it for distance estimation only if the received packet CRC is correct.

### REFERENCES

1—Lloyd Butler V K, “Inter-modulation Performance and Measurement of Inter-modulation Components”, http://www4.tpgi.com.au/users/ldbutler/Intermodulation.htm
2—“Theory or Inter-modulation Distortion Measurement (IMD)”, http://www.maurymw.com/support/PDFs/5c043.pdf
3—Anritsu, “Inter-modulation distortion (IMD)”, http://www.eetasia.com/ARTICLES/2002MAY/2002MAY10_NTEK_RF T_AN01.PDF

### APPENDIX B

The following is a portion of U.S. provisional patent application No. 60/736,587, filed Nov. 12, 2005. It will be understood that the figure numbers and reference numbers referred to in this Appendix B are figure numbers and reference numbers, respectively, from this provisional application which is incorporated herein by reference.

Techniques for RFID networking are provided. An RFID system includes both a star network and a mesh network operating in the same frequency band. The star network is configured for tag-to-reader communication, and the mesh network is configured for reader-to-reader communication. Different modulation procedures are utilized within each network to allow concurrent and independent communication over both the star and mesh networks.

In one embodiment of the present invention, an RFID system includes real-time, wireless star and mesh networks. The star network includes a plurality of tags in communication with a first reader at a carrier frequency using a first modulation procedure. The mesh network includes the first reader in communication with a second reader. Communication with the second reader is performed at the carrier frequency using a second modulation procedure. The second modulation procedure differs from the first modulation procedure to allow concurrent communication over the star network and the mesh network. At least one tag of the plurality of tags includes an environmental sensor, and environmental data can be transferred from the star network to the mesh network. In a specific embodiment, each reader and tag, as well as other components of the RFID system, can be camouflaged.

In another embodiment of the present invention, an RFID device includes circuitry to communicate with at least one sensor tag at a carrier frequency using a first modulation procedure. The reader further includes circuitry to communicate with a second RFID device at the carrier frequency using a second modulation procedure. The first modulation procedure differs from the second modulation procedure to allow concurrent communication by the first device with the at least one sensor tag and the second device.

In yet another embodiment of the present invention, a method of operating an RFID system is provided. A first reader is provided within an area. The first reader is configured to communicate with an RFID tag at carrier frequency using a first modulation procedure. RFID transmissions are monitored within the area by the first reader to detect signal from a second, or rogue, reader. The first and second readers communicate to authenticate an identity of the second reader. If authentication fails, the first reader reports the second reader (e.g. reports to another reader, or to a central controller of readers, that the second reader is not anthenticated) or otherwise initiates a predetermined alarm process.

Many benefits are achieved by way of at least certain embodiments of the present invention. For example, the present technique provides reader-to-reader communication which allows a reader population to self-manage, self-orchestrate, and self-diagnose relative to each other without the need for centralized control. Data can also be shared and correlated in real time so as to reduce the amount of traffic going to a central intelligence system. Readers collaborate in making decisions as small groups without needing to communicate across an entire network and waste battery life. Depending upon the embodiment, one or more of these benefits, as well as others, may be achieved.

FIG. 1 illustrates an exemplary RFID system 100 according to an embodiment of the present invention. System 100 includes a star network 102 and a mesh network 104. Star network 102 is designed for tag-to-reader communication, while the mesh network 104 is designed for reader-to-reader communication. These networks are linked together by shared or common reader(s) (e.g., reader 108(a)). In this way, data retrieved by a reader from any individual tag over the star network can be accessed by another reader on the mesh network.

In a specific embodiment, the star and mesh network operate within the same frequency band or with the same carrier frequency. This implementation provides many benefits, particularly avoiding the need to dedicate two frequency bands for an RFID system. In order to accomplish this feature, different modulation procedures are utilized within each network to allow concurrent and independent communication over both the star and mesh networks. Examples of modulation procedures include amplitude shift keying (ASK), frequency shift keying (FSK), phase shift keying (PSK), Gaussian frequency shift keying (GFSK), minimum-shift keying (MSK), Gaussian minimum shift keying (GMSK), any constant envelope modulation scheme, or the like.

FIG. 2 shows a simplified example of modulation of a single carrier signal for simultaneous operation of two independent networks. As shown, two differing modulation process can be applied to a single carrier signal. In this example, both ASK and FSK modulation procedures are applied, but other modulation techniques can work as well (e.g., PSK). Data encoded using a first modulation procedure is used by one network and data encoded by a second modulation procedure is independently used for another network (e.g., a reader-to-reader mesh network or a reader-to-tag star network). Depending on the RFID application, the carrier frequency band will vary depending on local governmental regulations. For applications within the United States, the carrier frequency can range from about 860 MHz to about 960 MHz.

However, in certain applications, it may be advantageous to dedicate a separate frequency band for the mesh network rather than use a different modulation procedure. For example, reader-to-reader communication can be segregated to a frequency band ranging from about 59 GHz to about 64 GHz, while tag-to-reader communication can remain at a frequency band ranging from about 860 MHz to 960 MHz. Keeping the tag-to-reader link at UHF frequencies provides more efficient power transfer for long operating distances. The higher band for the reader-to-reader link can provide one or more of these advantages:

(i) shorter wavelength, and thus increased positional resolution capabilities;

(ii) large available bandwidth with less interference;

(iii) high penetration loss confining signals to a room while also precluding radio sources outside the room;

(iv) smaller antenna size, which is better suited for phase array, beam steering, smart antennas, and MIMO (multiple-input-multiple-output) techniques; and

(v) reduced antenna cost by allowing micro strip antennas.

Referring back to FIG. 1, RFID system 100 includes tags 106, readers 108(a)-(d), and a communication device 110. Tags 106 are small RFID transponders. Tags 106 may be passive, semi-passive, or active devices. Readers 108 provide interrogation and command signals to tags 106. Readers 108 also serve as the lynch pin between star network 102 and mesh network 104 by passing of information therebetween. Communication device 110 couples, preferably wirelessly, readers 108 with a network uplink(s) 112. Network uplink 112 can be for a wireless wide area network (WWAN), wireless local area network (WLAN), satellite network, cellular network, global position system, or the like.

FIG. 3 illustrates a specific embodiment of an RFID system 300 according to the present invention. In this example, RFID system 300 include smart pebbles 306, smart rocks 308, and a smart boulder 310 to form one or more star networks 302 and one or more mesh networks 304. Smart pebbles 306, smart rocks 308, and smart boulder 310 are RFID devices that are camouflaged (e.g., appearing as natural rock, particularly of a kind found in a predetermined area of deployment, and can optionally include grassy out-growths as antennas). These devices are designed to go visually unnoticed when deployed. Camouflage material can also serve to absorb impact forces from aerial deployment, which allows sensor networks to be positioned in remote areas not otherwise easily accessible. The camouflage material can also serve yet another purpose: protect the internal electronics from harsh environments (e.g., temperature extremes, corrosives, moisture, salt mist, sand, or others). Examples of camouflage material include plastics, synthetic resinous materials (e.g., Styrofoam from Dow Chemical Company), glass, fiberglass, rubber, and the like.

Besides outward appearance, these RFID devices differ functionally from tags 106, readers 108, and communication device 110. For example, as shown in FIG. 4A, a smart pebble 306 is a small RFID transponder that includes an external or integrated sensor 402. Smart pebble 306 also utilizes a battery 404 to power sensor 402. Sensor 402 can be a magnetic, acoustic, seismic, infra-red, biological, chemical, radiation, temperature, or humidity sensor. To be more precise, smart pebble 306 can be configured to collect particular environmental data and communicate it to an uplink (via the star and/or mesh networks). This environmental data can indicate the presence in an area of a person, vehicle, chemical, radiation, biological agent, or the like.

In a specific implementation of smart pebble 306, a Nanoblock® IC device manufactured by Alien Technology Corporation is used. FIG. 4B shows various examples of Nanoblock® ICs and their relative size in comparison to the letter “D” of a U.S. dime coin. It should be appreciated that smart pebble 306 can be made very small, such less than 100 mm², or even less than 10 mm². As stated above, in particular applications, it is also desirable to camouflage smart pebble 306. That is to say, smart pebble 306 can be designed to conceal its presence by appearing as a common item or being embedded in a common item. FIG. 4C shows a smart pebble 306 concealed as a pebble. Optionally, smart pebble 306 can include grassy out-growths (not shown). The out-growths can serve as one or more antennas if comprised of a conductive material.

FIG. 5 illustrates another embodiment of smart pebble 306. In this example, a multi-sensor smart pebble 306 includes dual polarization antennas and a plurality of sensors 502 on a flexible substrate 504. The antennas and sensors 502 are electrically coupled to a processor multi-chip module 506. A plurality of batteries 508 are used to provide power to sensors 502. Sensors 502 can include one or more of magnetic, acoustic, seismic, infra-red, biological, chemical, radiation, temperature, or humidity sensors. It should be understood, that in order to conserve battery power, smart pebbles 306 can be configured to operate a desired subset of sensors 502 and leave the remaining sensors without power.

Low cost manufacturing techniques can be used to produce smart pebbles 306 in high volumes, such as on- or off-pitch roll-to-roll processes (or, alternatively, reel-to-reel, tape-to-tape, or sheet-to-sheet processes). Smart pebbles may also be fabricated through a fluidic self-assembly (FSA) process, as described in U.S. Pat. No. 6,864,570, entitled “Method for fabricating self-assembling microstructures,” which is incorporated by reference herein. For further efficiency, RFID strap based techniques can be applied too as described in U.S. Pat. No. 6,606,247, entitled “Multi-Feature-Size Electronic Structures,” which is hereby incorporated by reference.

Many benefits are achieved using smart pebbles. For example, backscatter based smart pebbles consume orders of magnitude less power than conventional active transmission systems, since no power is harnessed from a battery to be converted for radiation. It is also easier to detect backscatter signals with a high dynamic range transceiver because the reflected signal is phase synchronized and coherent with the transmitted signal. Typical power consumption is less than about 20-micro-watts peak and less than about 100 nano-watts standby. For similar link margin in real-world environments, active devices use at least 100 times more power to both overcome inefficiencies for radiating the power, as well as greater difficulty in recovering a non-phase coherent signal over a non-synchronous link. Depending upon the embodiment, one or more of these benefits may be achieved.

FIGS. 6A-C illustrate an exemplary smart rock 308 according to an embodiment of the present invention. Smart rock 308 provides interrogation and command signals to smart pebbles 306. In this example, smart rock 308 includes a single antenna 602 coupled to a circulator 604 for transmitting and receiving, but in alternative embodiments it may have two or more antennas. One antenna can be dedicated for transmitting and another for receiving.

Smart rock 308 further includes an adaptive digital radio 606. Smart rock 308 recognizes one or more external conditions and modifies its operation through adaptive digital radio 606 in response to these conditions. External factors can include historical read rates, composition of tag population, characteristics of the backscatter signal, and location information of interferers. A soft engine, parallel receiver channels, and predictive models can be employed to adapt smart rock 308. Techniques for adaptive RFID devices are described in U.S. Provisional Patent Application No. 60/729,144 (Attorney Docket No. 03424.P095Z), filed Oct. 10, 2005, entitled “Adaptive RFID Devices,” which is hereby incorporated herein by reference.

Smart rock 308, as illustrated FIG. 6B, can be made very small, such less than about 1558 mm², or even less than about 768 mm². A small size allows its use in many more applications. The small size also provides for easier concealment. In particular applications, it is also desirable to camouflage smart rock 308 as shown in FIG. 6C.

FIG. 7 illustrates a simplified block diagram of an exemplary smart boulder 310 according to an embodiment of the present invention. Smart boulder 310 provides interfaces (e.g., WWAN RF module 702, satellite RF module 704, cellular RF module 706, GPS receiver 708, and the like) with one or more remote networks. It is configured to communicate with an uplink over these interfaces, as well as with smart rocks 308 and/or smart pebbles 306 using UHF-RFID module 710.

Smart boulder 310 provides the sensor intelligence of system 300. I other words, sensor network intelligence 712 of smart boulder 310 can process received sensor tag data and act upon it. For example, smart boulder 310 can correlate data from nearby sensor tags to determine if an individual tag is functioning properly. As another example, smart boulder 310 can selectively activate different sensor tags (or sensors) to conserve tag battery power. Besides processing tag sensor data, smart boulder 310 can also generate its own data by providing one or more sensors. As smart boulder 310 is typically much larger than smart rocks 308 or smart pebbles 306, it can accommodate relatively larger sensors, such as video imager 714 and an audio sensor 716 applying independent component analysis (ICA) techniques. ICA is a signal processing technique that utilizes the independence properties of signal sources from multiple generators to separate signals from noise. This technique has been demonstrated to be very successful for audio signal processing. Additional background information relating to ICA is provided by “Independent Component Analysis: Algorithms and Applications” by Aapo Hyvarinen and Erkki Oja of Helsinki University of Technology, which is incorporated by reference herein.

Smart boulder 310 also includes multiple-input multiple-output (MIMO) circuitry 718. MIMO circuitry 718 makes use of multiple transmit and receive antennas, or antenna diversity, to address Rayleigh fading in a multi-path environment. That is to say, fading at each antenna is statistically independent of the other antennas and resulting signals can be combined to produce an output signal. MIMO circuitry 718 has superior a signal-to-noise ratio as each antenna signal is combined in phase, while noise is added incoherently. In alternative embodiments, MIMO circuitry 718 can use antenna selection diversity to select an antenna with highest received signal power, or use switched multi-beam techniques to select the beam with the highest signal-to-noise ratio.

FIGS. 8A-B show deployment patterns for smart pebbles 802 to monitor movement in a remote, inaccessible, or isolated geographical area of interest (such as a national border, battlefield, high security area, or the like). In this example, sensors for smart pebbles 802 are configured to detect, directly or indirectly, the presence of an individual 804. Detection can be based on heat, vibration, vision (image processing), acoustic noise (e.g., speech or movement), changes in RF spectrum, or other detectable characteristics. U.S. patent application Ser. No. 11/136,591, entitled “Interrogator with Human Presence Detector,” to Curtis A. Carrender details certain techniques for detecting the presence of a human being, which is hereby incorporated by reference for all purposes.

In FIG. 8A, the density and detection range of smart pebbles 802 results in a generally undesired coverage gap 806. Preferably, as shown in FIG. 8B, the density and detection range of smart pebbles 802 results in overlapping coverage areas with no coverage gaps (alternatively, small gaps or reduced probability of gaps). It should be understood that for a desired coverage area smart pebble density is inversely related to the detection range of each smart pebble (e.g., increased detection range results in fewer needed smart pebbles). Also, high deployment density can compensate for low single sensor probability of detection for improved system level probability of detection. A system may include any number of sensor tags (e.g., 20, 100, 1000, 5000, or more sensor tags), but preferably at least 5 sensor tags per one meter², or more preferably at least 15 sensor tags per two meter².

FIG. 9 shows a simplified method 900 for operating an RFID system. In step 902, RFID device are disposed in an area. For example, smart pebbles, smart rocks, and a smart boulder can be dispersed by an aerial drop. In step 904, smart rocks can communicate with smart pebbles by modulating a carrier signal using a first procedure, such as ASK. The backscatter modulated signal for smart pebbles can communicate data (e.g., environmental sensor data) to the star network in step 906. In step 908, smart rocks can modulate a carrier signal using a second procedure, such as FSK. Thus, data can be communicated between smart rocks to form a mesh network in step 910. In step 912, smart rocks uplink data to a WWAN. In one embodiment, the uplink is accomplished via a smart boulder. Many modifications to method 900 are possible without deviating from the scope of the invention.

FIG. 10 illustrates an exemplary system 1000 for implementing an RFID community watch in which at least one trusted reader monitors an area for other, unauthorized RFID sources. In this example, system 1000 includes two trusted readers 1002(a)-(b) electronically linked (by wire or wirelessly) with an enterprise information system 1004, a computing system configured to provide services to a large organization and typically handling large data volumes. Optionally, middleware acts as an intermediary between readers 1002(a)-(b) and the enterprise information system 1004. Each of readers 1002(a)-(b) can interrogate tags 1006 within the area in a conventional manner. However, readers 1002(a)-(b) have the additional functionality of recognizing interrogation signals from an unknown RFID source, such as a rogue reader 1008, or recognizing backscatter signals from tags 1006 in response the unknown source.

In the event a rogue reader 1008 is detected by system 1000, readers 1002(a)-(b) can challenge rogue reader 1008 for authentication information. Authentication information can take the form of an identifier, password, encryption key (for use in private and/or public key cryptographic methods), or the like. If rogue reader 1008 is properly authenticated, system 1000 allows the now identified rogue reader 1008 to operate. System 1000 may also log authorization information for rogue reader 1008 in a database for future reference, and thus avoid future challenges.

If rogue reader 1008 fails to be authenticated, a trusted reader can relay information to enterprise information system 1004 or initiate a predetermined alarm procedure. For instance, reader 1002(a) can sound an alarm (audio or visual), send an electronic email alert, interfere with commands or RF transmissions from rogue reader 1008 (e.g., continuous broadcast of SLEEP commands to tags 1006 at maximum power at the same carrier frequency), kill tags within the area, command tags not to respond to rogue reader 1008, or command tags to respond to rogue reader 1008 with incorrect or false information.

In an alternative embodiment, system 1000 can be configured such that each trusted reader periodically transmits a specific or predetermined signal when it attempts to communicate with tags. This specific signal can be obscured from being discovered by an eavesdropping party. As an example, this specific signal could be at a different frequency from the normal tag communication frequency. As another example, this specific signal could be a sequence of standard reader commands, but performed in a particular order, or with certain timing, in order to provide an indication of authorization. The exact details of this special command could be determined by reference to an algorithm dependent on an internal or external clock, so that an eavesdropper could not readily determine the authorization sequence.

Detection of rogue reader 1008 can be particularly useful in a retail environment. Without a system 1000 according to an embodiment of the present invention, a competitor can walk through a store with a rogue reader 1008 and quickly capture the store's complete product selection (e.g., type, quantities available, remaining shelf life of items, and like). In fact, a competitor can deduce sensitive sales information by capturing one's inventory multiple times over a period. Pricing and discount information can also be surreptitiously obtained if stored within item tags or smart shelves.

In one embodiment of the present invention, readers 1002(a)-(b) can additionally determine the relative location of rogue reader 1008 in the area using range and bearing techniques. U.S. patent application Ser. No. 11/080,379, entitled “Distance/ranging determination using Relative Phase Data” to Curtis L. Carrender and John M. Price, describes specific range and bearing techniques and is hereby incorporated by reference for all purposes. Providing location information can be helpful in quickly locating and removing the rogue reader 1008. Determination of rogue reader 1008 location can also be used by system 1000 to determine whether rogue reader 1008 is an intruder. For example, system 1000 can determine if rogue reader is physically disposed inside a predetermined area.

If readers 1002(a)-(b) have known locations, then readers 1002(a)-(b) can translate the relative location of rogue reader 1008 to specific coordinates (e.g., latitude and longitude). Readers 1002(a)-(b) can employ a global positing system (GPS) or a landmark beacon/fiducial tag 1010 to determine its location. Further, the GPS system can be utilized at one or more instances or locations in the network to serve as absolute location anchor points. Range and bearing techniques in combination with a tilt sensor (such as a single-, dual-, or triple-axis microelectromechanical tilt sensor) and/or electronic compass can then be used to determine all node locations relative to an instance. Tilt sensors can be helpful to sense pitch, for example in the event a sensor lands on hilly terrain. Direction can be determined by the electronic compass, particularly if a GPS signal is weak or unavailable.

Additional GPS instances may be added for improved accuracy by comparing absolute location information with relative location information. Implementations may also use of fiducial tags as described in U.S. patent application Ser. No. 11/136,591, entitled “Location Management for Radio Frequency Identification Readers,” which is hereby incorporated herein by reference.

FIG. 11 shows a simplified method 1100 for operating an RFID community watch system. In step 1102, a first reader is provided in an area. This reader is known and/or authorized to operate in the area. The first reader, in step 1104, monitors RFID signals within the area. If RFID transmissions are detected by the first reader in step 1106, it communicates with the RFID source (e.g., a rogue reader) to obtain identification or authentication information. The first reader in step 1110 determines if the RFID source is authorized to operate in the area. If not, the first reader reports the rogue reader in step 1112 to an enterprise information system, or alternatively sounds an alarm, logs the event, or takes other precautionary actions. Many modifications to method 1100 are possible without deviating from the scope of the invention.

What is claimed is:

1. An RFID reader comprising:
a processor;
at least one antenna;
a switch controlled by the processor; and
at least two receiver channels in a radio frequency front-end section coupled to the at least one antenna and the switch, the at least two receiver channels including:
a first receiver channel configured to provide a gain for a received signal of a first predetermined range in strength, the gain being substantially linear over the first predetermined range; and
a second receiver channel configured to provide a gain for a received signal of a second predetermined signal range in strength, the gain being substantially linear over the second predetermined range.

2. The RFID reader of claim 1 wherein the gain of the first receiver channel is relatively higher than the gain of the second receiver channel.

3. The RFID reader of claim 2 wherein a maximum in signal strength of the first predetermined range is less than a maximum in signal strength of the second predetermined range.

4. The RFID reader of claim 1 wherein a maximum region of the first predetermined range overlaps with a minimum region of the second predetermined range.

5. The RFID reader of claim 1 wherein the processor is configured to make a selection of a receiver channel depending on signal strength.

6. The RFID reader of claim 5 wherein the selection occurs during a preamble sequence.

7. The RFID reader of claim 1 wherein the first predetermined range ranges from about 1 μV to about 1 mV.

8. The RFID reader of claim 1 wherein the second predetermined range ranges from about 1 mV to about 100 mV.

9. The RFID reader of claim 1 further comprising a mixer to mix a received signal with an intermediate frequency signal.

10. The RFID reader of claim 1 further comprising a third receiver channel configured to provide a gain for a received signal of a third predetermined range in strength, the third predetermined range encompassing at least a portion of both the first and second predetermined ranges.

11. The RFID reader of claim 1 further comprising at least one of a directional coupling element and an isolator element electrically coupled to the plurality of receiver channels.

12. The RFID reader of claim 11 wherein the isolator element is a circulator.

13. The RFID reader of claim 1 wherein each of the at least two receiver channels includes a band pass filter.

14. An RFID reader comprising:
a processor;
at least one antenna;
a switch controlled by the processor; and
at least two receiver channels coupled to the at least one antenna and the switch, the at least two receiver channels including:
a first receiver channel configured to provide a gain for a received signal of a first predetermined range in strength, the gain being about linear with a root-mean-square deviation of less than 5% over the first predetermined range; and
a second receiver channel configured to provide a gain for a received signal of a second predetermined signal range in strength, the gain being about linear with a root-mean-square deviation of less than 5% over the second predetermined range.

15. A method of operating an RFID device, the method comprising:
transmitting an interrogation signal;
receiving a backscatter signal;
determining a signal strength of the received backscatter signal;
in response to the determining, selecting a receiver channel from a plurality of receiver channels to reduce inter-modulation distortion, each receiver channel to provide a substantially linear gain over a specified range.

16. The method of claim 15 wherein the plurality of receiver channels includes:
a first receiver channel configured to provide a gain for a received signal of a first predetermined range in strength; and
a second receiver channel configured to provide lower gain relative to the first receiver channel for a received signal of a second predetermined signal range in strength.

17. The method of claim 16 further comprising:
disposing a tag within an RF field of at least two readers,
wherein a received signal from the tag is within the second predetermined signal range.

18. The RFID reader of claim 16 wherein the first predetermined range ranges from about 1 μV to about 1 mV.

19. The RFID reader of claim 16 wherein the second predetermined range ranges from about 1 mV to about 100 mV.

20. The method of claim 14 wherein the determining occurs during a preamble signal defined by an RFID protocol.

21. An RFID reader comprising:
a processor;
a transceiver;
at least one antenna coupled to the transceiver;
at least one reconfigurable hardware element, the hardware element reconfigurable by the processor in response to a predetermined condition; and
non-volatile memory storing configuration code for the reconfigurable hardware element.

22. The reader of claim 21 wherein the reconfigurable hardware element is a field programmable gate array (FPGA).

23. The reader of claim 22 further comprising at least one analog-to-digital converter and at least one digital-to-analog converter.

24. The reader of claim 21 wherein the hardware element is reconfigurable by the processor in real-time with the experienced condition.

25. The reader of claim 21 wherein the predetermined condition is the detection of a mixed tag population.

26. The reader of claim 25 wherein the mixed tag population includes two tags operating on differing protocols.

27. The reader of claim 26 wherein the protocols are at least one of a Class 0 specification, C1G1 specification, C1G2 protocol, ISO 18000-6a protocol, ISO 18000-6b protocol, 18000-6c protocol, and ISO15693 protocol.

28. The reader of claim 21 wherein the predetermined condition is an operating frequency of a tag.

29. The reader of claim 21 wherein the frequency of the tag is at least one of low frequency, high frequency, and ultrahigh frequency.

30. The reader of claim 21 wherein the frequency of the tag ranges from 860 MHz to 960 MHz.

31. The reader of claim 21 wherein a first antenna is configured to receive RF signals for a listen-before-talk reader and to transmit an interrogation signal.

32. The reader of claim 21 wherein the programmable processor is at least one of a digital signal processor, micro-controller, and general purpose processor.

33. The reader of claim 32 wherein a protocol is implemented by three computing cores, the three computing cores being the reconfigurable hardware element, a digital signal processor, and a general purpose processor.

34. The reader of claim 21 wherein the predetermined condition is a read rate of the reader over a time period.

35. The reader of claim 21 wherein the predetermined condition is determined from a first predictive model using a read rate during a first time period and a second predictive model using a read rate during a second time period, the second time period being relatively shorter than the first time period.

36. The reader of claim 35 wherein the second period is at least one of (i) less then 30 seconds, (ii) less than 15 seconds, and (iii) less than one second.

37. The reader of claim 36 wherein the time period is at least one of (i) longer than 5 minutes, (ii) longer than 10 minutes, and (iii) longer than 20 minutes.

38. The reader of claim 35 wherein the first time period includes the second time period.

39. The reader of claim 35 wherein the at least one reconfigurable hardware element alters a read rate of the reader based upon the predetermined condition.

40. The reader of claim 39 wherein the read rate of the reader can range from a predetermined minimum value to a predetermined maximum value.

41. The reader of claim 21 wherein the predetermined condition is a detected bearing of a tag.

42. An RFID reader comprising:
a processor;
at least one antenna;
a switch controlled by the processor; and
at least two receiver channels coupled to the at least one antenna and the switch, the at least two receiver channels including:
a first receiver channel configured to provide a first gain for a received signal of a first predetermined range in strength, the first gain being substantially linear over the first predetermined range; and
a second receiver channel configured to provide a second gain for a received signal of a second predetermined signal range in strength, the second gain being substantially linear over the second predetermined range; and
at least one baseband receiver channel providing a third gain for a received signal after demodulation to a baseband.

43. A method of operating an RFID system, the method comprising:
providing a tag population including first tags configured for a first communication protocol and second tags configured for a second communication protocol;
configuring a reader for communication using a first protocol;
commanding the first tags to an unresponsive state;
after the commanding, configuring the reader for communication using a second protocol; and
communicating by the reader with the second tags.

44. The method of claim 43 further comprising, after communicating by the reader with the second tags, reconfiguring the reader for communication using the first protocol and communicating by the reader with the first tags.

45. The method of claim 43 wherein the unresponsive state is a SLEEP state.
